(19) United States
(12) Patent Application Publication
(10) Pub. No.: US 2006/0279785 A1
(43) Pub. Date: Dec. 14, 2006

(54) Image generating apparatus, image forming apparatus, information processing apparatus, printing medium, image generating method, and program

(75) Inventors: Takeshi Onishi, Kanagawa (JP); Yasunori Saito, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/250,401

(22) Filed: Oct. 17, 2005

(30) Foreign Application Priority Data
Jun. 10, 2005 (JP) P2005-171684

(51) Int. Cl. G06K 15/00

(52) U.S. Cl. 358/1.18; 358/1.15

(57) ABSTRACT

An image generating apparatus includes a position information acquiring unit that acquires position information indicating each of positions on a medium, an identification information acquiring unit that acquires identification information identifying an electronic document or the medium, the electronic document being a basis of a document image formed on the medium, an additional information acquiring unit that acquires additional information used for a user application program, and a code image generating unit that generates a code image indicating the position information acquired by the position information acquiring unit, the identification information acquired by the identification information acquiring unit, and the additional information acquired by the additional information acquiring unit.

### BACKGROUND OF THE INVENTION

1. Field of the Invention

The present invention relates to an image generating apparatus for generating an image printed in an image forming apparatus such as a copier and a printer, an image forming apparatus such as a copier and a printer, a printing medium printed in the image forming apparatus, and an information processing apparatus for reading information from the printing medium and processing the information.

2. Description of the Related Art

Recently, much attention has been paid to a technique for writing characters or diagrams on a particular paper on which fine dots are printed, transmitting the characters or the like written on the paper by a user to a personal computer or a mobile phone, and capable of preserving or mailing the contents therein. In the technique, small dots are printed in an interval of, for example, 0.3 mm on the particular paper, and for example, the dots constitute different patterns in corresponding grids having a predetermined size. By reading the paper with a dedicated pen having, for example, a built-in digital camera, positions of the characters or the like written on the particular paper can be specified, and the characters or the like can be used as electronic information.

As a conventional technique disclosed in Patent Documents, there is a technique for binding an electronic document and a paper on which the electronic document is printed with a string and integrating characters or the like written on the paper with the electronic document. More specifically, identification information on electronic document pages and position information on the paper are embedded in a code image, of which representative one is machine-readable two-dimensional code or the like, and then, overlapped with the electronic document and printed by a printer or the like. Next, by using a pen type scanner, writing motion on the printed document and partial images of writing positions is continuously acquired from the printed document. Next, by analyzing the acquired image, plural position information of the identification information of the electronic document pages and the partial image is detected. After that, the original electronic document pages is identified by using the detected identification information, and at the same time, the contents written on the printed document is reproduced by using plural position information, so that it is possible to add the written contents to the original electronic document pages

However, in the invention disclosed in the patent document described above, the position information indicating positions on the paper, the identification information of the electronic document pages, and information used for error correction are simply stored in the code image. Therefore, in a case where a service is provided by using such a printed document, since information required for providing the service cannot be embedded in the code image, there is a problem in that a degree of freedom for the serve is limited.

More specifically, when access to the electronic document is performed based on the identification information printed on the paper, there may be a case where an operation intends to be changed in some electronic document. For example, according to an intention of a writer of the electronic document, there may be a case where handwriting information written on the printed document intends to be represented on the original electronic document for an arbitrary electronic document but not to be represented on the original electronic document for a separate electronic document. In addition, there may be a case where handwriting information on the printed document intends to directly added to an arbitrary document but to manage the electronic document to which the handwriting information of the printed document in separation from the original electronic document for a separate electronic document. In addition, among original electronic documents, there are document on which some information intends not to be disclosed carelessly in order to preserve and sustain secrecy. However, in the document previously described above, access control or the like is not performed, but the electronic document is directly accessed based on the identification information in the paper.

### SUMMARY OF THE INVENTION

The present invention has been made in view of the above circumstances and provides an image generating apparatus.

According to an aspect of the present invention, an image generating apparatus includes a position information acquiring unit that acquires position information indicating each of positions on a medium, an identification information acquiring unit that acquires identification information identifying an electronic document or the medium, the electronic document being a basis of a document image formed on the medium, an additional information acquiring unit that acquires additional information used for a user application program, and a code image generating unit that generates a code image indicating the position information acquired by the position information acquiring unit, the identification information acquired by the identification information acquiring unit, and the additional information acquired by the additional information acquiring unit.

According to another aspect of the present invention, an image forming apparatus includes a document image generating section that generates a document image formed on a medium, a code image generating section that generates a code image indicating position information indicating each of positions on the medium, identification information identifying an electronic document or the medium, the electronic document being a basis of the document image, and additional information used for a process for the electronic document or the medium, an image combining section that combines the document image generated by the document image generating section with the code image generated by the code image generating section, and an image forming section that forms an image combined by the image combining section on the medium.

According to another aspect of the present invention, an information processing apparatus includes an additional information acquiring section that acquires additional information additionally provided to position information indicating each of positions on a medium and to identification information identifying data or the medium, the data being a basis of an image formed on the medium in a code image formed on the medium, and a processing section that performs a predetermined operation according to the additional information acquired by the additional information acquiring section.

According to another aspect of the present invention, a printing medium includes a first image based on predetermined data, and a second image indicating position information on a plane having extended portions in two different directions of the second image, identification information identifying the second image or the data, and additional information used for a process for the second image or the data.

According to another aspect of the present invention, an image generating method includes acquiring position information indicating each of positions on a medium, acquiring identification information identifying data or the medium, the data being a basis of an image formed on the medium, acquiring additional information used for a user application program, and generating a code image indicating the position information, the identification information, and the additional information.

According to another aspect of the present invention, a storage medium readable by a computer, the storage medium storing a program of instructions executable by the computer to perform a function for generating image, the function including the steps of acquiring position information indicating each of positions on a medium, acquiring identification information identifying data or the medium, the data being a basis of an image formed on the medium, acquiring additional information used for a user application program, and generating a code image indicating the position information, the identification information, and the additional information.

According to another aspect of the present invention, a storage medium readable by a computer, the storage medium storing a program of instructions executable by the computer to perform a function for generating image, the function including the steps of acquiring additional information additionally provided to each of position information indicating positions on a medium and to identification information identifying the medium or data which is a basis of an image formed on the medium in a code image formed on the medium, and performing a predetermined operation according to the acquired additional information.

### BRIEF DESCRIPTION OF THE DRAWINGS

Embodiments of the present invention will be described in detail based on the following figures, wherein:

FIG. 1 is a view showing a whole construction of a system to which a first embodiment of the present invention is applied;

FIG. 2 is a view showing a functional construction associated with image generating of an identification information managing server according to an embodiment of the present invention;

FIG. 3 is a flowchart showing operations associated with image generating of an identification information managing server according to an embodiment of the present invention;

FIG. 4 is a view showing an example of a construction of an image forming apparatus according to an embodiment of the present invention;

FIGS. 5A to 5C are views for explaining a two-dimensional code image printed on a medium according to an embodiment of the present invention;

FIG. 6 is a view for explaining an additional code according to the first embodiment of the present invention;

FIG. 7 is a view showing an example of contents stored in a correspondence information DB according to the first embodiment of the present invention;

FIG. 8 is a view showing an example of a construction of a pen device according to the first embodiment of the present invention;

FIG. 9 is a view showing operations of a pen device according to the first embodiment of the present invention;

FIGS. 10A and 10B are views for explaining reading of code information by a pen device according to the first embodiment of the present invention;

FIG. 11 is a view showing a functional construction associated with a process based on additional information of an identification information managing server according to the first embodiment of the present invention;

FIG. 12 is a flowchart showing operations based on additional information of an identification information managing server according to the first embodiment of the present invention;

FIG. 13 is a view showing a whole construction of a system to which a second embodiment of the present invention is applied;

FIG. 14 is a view for explaining an additional code according to a second embodiment of the present invention;

FIG. 15 is a view showing a functional construction associated with a process based on additional information of an image forming apparatus according to a second embodiment of the present invention; and

FIG. 16 is a flowchart showing operations based on additional information of an image forming apparatus according to a second embodiment of the present invention.

### DETAILED DESCRIPTION OF THE INVENTION

Now, best modes for carrying out the present invention (hereinafter, referred to as embodiments) will be described in detail with reference to the accompanying drawings.

### FIRST EMBODIMENT

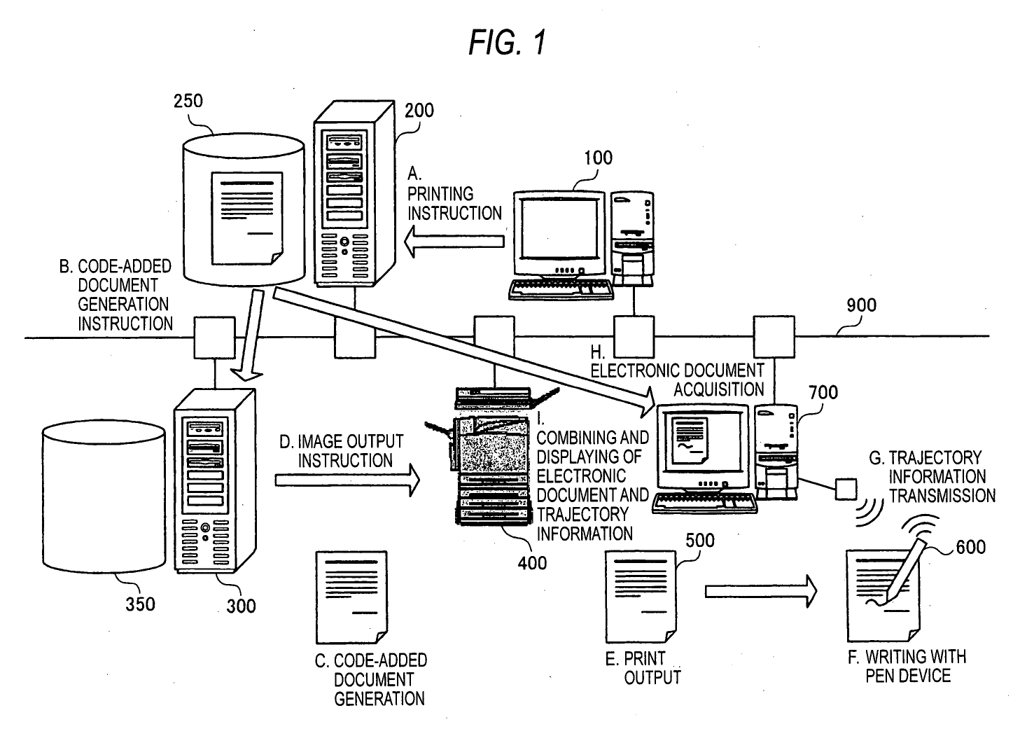

FIG. 1 shows an example of a construction of a system to which a first embodiment is applied. The system is constructed by connecting at least a terminal apparatus 100 for commanding printing of an electronic document, a document managing server 200 for managing a to-be-printed electronic document, an identification information managing server 300 for generating a code-added document where a code image indicating identification information is added to a document image of the printing-commanded electronic document, and an image forming apparatus 400 for printing the code-added document with a network 900.

In addition, a document repository 250 which is a storage unit for storing the electronic document is connected to the document managing server 200, and an identification information repository 350 which is a storage unit for storing the identification information is connected to the identification information managing server 300. In addition, in the embodiment, the identification information may be used to identify the medium or the electronic document.

In addition, the system includes a code-image-added paper 500 output from the image forming apparatus 400 and a pen device 600 for writing characters or diagrams on the code-image-added paper 500 and reading writing information of the characters or the diagram. In addition, a terminal apparatus 700 for overlapping and displaying the document managed by the document managing server 200 and the writing information read by the pen device 600 is also connected to the network 900.

Now, operations of the system will be described in brief.

Firstly, the terminal apparatus 100 commands the document managing server 200 to print a specific electronic document managed in the document repository 250 (A). At this time, a printing attribute such as paper size and direction or additional information which a user application program (hereinafter, refereed to as AP) uses to perform a process based on a print material is also input from the terminal apparatus 100.

By doing so, the document managing server 200 transmits the printing-commanded electronic document, the printing attribute, and the additional information to the identification information managing server 300 and commands the identification information managing server 300 to generate the code-added document by adding a code image indicating identification information or the like to the document image of the electronic document (B). The commanded identification information managing server 300 generates the code-added document for the document image of the commanded electronic document by adding the code image indicating identification information or the like managed in the identification information repository 350 (C).

In addition to identification information, the information added as a code image includes position information for specifying a coordinate position (X coordinate and Y coordinate) on a paper. In addition, in the embodiment, the additional information input form the terminal apparatus 100 is also included in the code image.

Next, the identification information managing server 300 commands the image forming apparatus 400 to output an image of the code-added document (D). By doing so, the image forming apparatus 400 outputs the code-image-added paper 500 (E).

In addition, as described later in detail, the image forming apparatus 400 forms the code image added in the identification information managing server 300 as an invisible image by using an invisible toner and the other images (images contained in an original electronic document) as a visible image by using a visible toner.

After that, a user writes (hand-writes) characters or diagrams on the code-image-added paper 500 with the pen device 600 (F). By doing so, an image pickup device of the pen device 600 picks up a predetermined region of the code-image-added paper 500 to acquire the position information, the identification information, and the additional information. Next, trajectory information of the characters or the diagrams acquired form the position information, the identification information, and the additional information are transmitted to the terminal apparatus 700 in a wire or wireless manner (G). In addition, in the system, a invisible image is formed by using an invisible toner having a infrared light absorbance which is higher than a predetermined reference value, and the invisible image can be read with the pen device 600 which can perform infrared light illuminating and sensing.

By doing so, the terminal apparatus 700 acquires a specific page of a specific electronic document which is an object of printing from the document managing server 200 by using the identification information as a key (H), and combines the page and the trajectory information transmitted from the pen device 600 to perform displaying thereof (I). In addition, for example, the additional information is used to determine whether or not access to the electronic document managed by the document managing server 200 is accepted. In the embodiment, the identification information managing server 300 performs the determination. Therefore, finally, although the object electronic document is acquired from the document managing server 200, a query whether or not the access to the electronic document is accepted is sent to the identification information managing server 300 in the embodiment.

However, this construction is one example, and thus, functions of the identification information managing server 300 may be provided to the document managing server 200 or implemented as functions of the image processing units of the image forming apparatus 400. In addition, although the electronic document is described as the printing object in the embodiment, the present invention can be applied to printing of electronic data, for example, such as a picture image or the like which is not include in the scope of the electronic document.

Next, a construction of the system shown in FIG. 1 will be described in more detail.

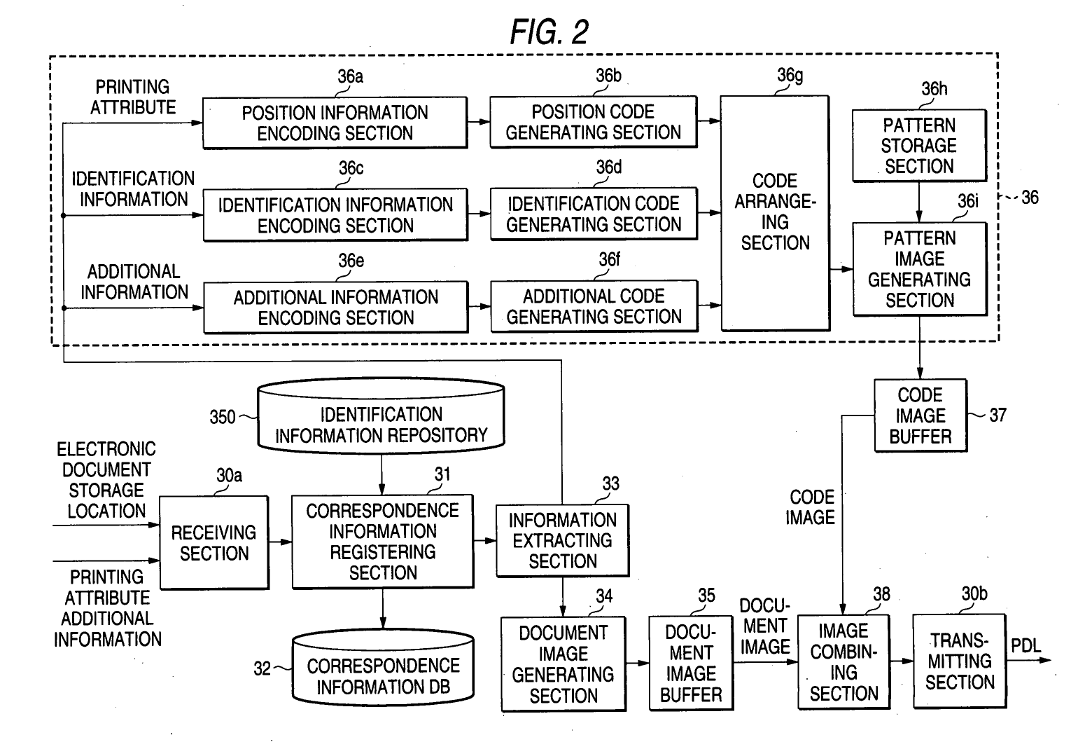

FIG. 2 is a view showing an example of a construction of the identification information managing server 300. In addition, for convenience of description, the identification information repository 350 is also shown in the figure.

The identification information managing server 300 includes a receiving unit 30a, a correspondence information registering unit 31, a correspondence information database (DB) 32, an information extracting unit 33, a document image generating unit 34, a document image buffer 35, a code image generating unit 36, a code image buffer 37, an image combining unit 38, and a transmitting unit 30b.

In addition, the code image generating unit 36 includes a position information encoding unit 36a, a position code generating unit 36b, an identification information encoding unit 36c, an identification code generating unit 36d, an additional information encoding unit 36e, an additional code generating unit 36f, a code arranging unit 36g, a pattern storage unit 36h, an pattern image generating unit 36i.

The receiving unit 30a receives a to-be-printed electronic document, a storage location thereof, a printing attribute (paper size, direction, or the like), and additional information from the network 900 and transmits the information to the correspondence information registering unit 31.

The correspondence information registering unit 31 acquires identification information form the identification information repository 350, corresponds the storage location or the like acquired from the receiving unit 30a with identification information, and registers the correspondence.

The correspondence information DB 32 is a database for storing correspondence among the identification information, the storage location of the electronic document, and the additional information (if necessary) according to a command of the correspondence information registering unit 31.

The information extracting unit 33 extracts information (printing attribute, identification information, and additional information) needed to generate the code image from the information acquired by the correspondence information registering unit 31.

The document image generating unit 34 generates an image for the electronic document from the information extracted by the information extracting unit 33 and stores the image in the document image buffer 35.

The code image generating unit 36 generates a code image by using the information extracted by the information extracting unit 33 and stores the code image in the code image buffer 37.

The image combining unit 38 combines the document image stored in the document image buffer 35 with the code image stored in the code image buffer 37.

The transmitting unit 30b transmits a command of outputting the image combined by the image combining unit 38 as a PDL (Page Description Language) of which representative one is PostScript to the image forming apparatus 400.

The position information encoding unit 36a encodes the position information according to a predetermined encoding scheme. For the encoding, existing error correction codes, for example, an RS (Reed Solomon) code or a BCH code may be used. In addition, a CRC (Cyclic Redundancy Check) or check sum value of the position information is calculated as an error detection code, and the value may be added as a redundancy bit to the position information. In addition, an M-series code which is a kind of a pseudo noise series may be used as position information. The M-series code is obtained by performing the encoring by using a characteristic in that, in case of a P-th order of M series (series length: 2^{P-1}), when a partial series having a length P is extracted from the M series, a bit pattern occurring in the partial series occurs in the M series at the only one time. In addition, in terms of acquiring the position information, the position information encoding unit 36a may be treated as position information acquiring means.

The position code generating unit 36b converts the encoded position information into a format embedded as the code information. For example, in order that a third party can not decode the encoded position information, the arrangement of bits in the encoded position information may be exchanged or encrypted by using a pseudo random number. In addition, in a case where the position code is two-dimensionally arranged, the bit value is also two-dimensionally arranged similar to the arrangement of the code.

In addition, in the embodiment, the information extracting unit 33 transmits the printing attribute such as paper size and direction to the position information encoding unit 36a, and the position information encoding unit 36a selects one corresponding to the transmitted printing attribute among encoded position information generated and stored for the printing attribute in advance. The reason is that, if the paper size or direction is determined, the position code printed on the paper can be specified as a single one.

On the other hand, in a case where the printing paper size or direction is the same, the position code printed on the paper is always the same. Therefore, in a case where the printing is performed in only the same paper size or direction, the position information encoding unit 36a and the position code generating unit 36b may be integrated as a position code storage unit for storing one set of position code, and the position code may be always used.

If the identification information is input, the identification information encoding unit 36c encodes the identification information according to a predetermined encoding scheme. For the encoding, the encoding scheme used for the encoding of the position information may be used. In addition, in terms of acquiring the identification information, the identification information encoding unit 36c may be treated as identification information acquiring means.

The identification code generating unit 36d converts the encoded identification information into a format embedded as the code information. For example, in order that a third party can not decode the encoded position information, the arrangement of bits in the encoded identification information may be exchanged or encrypted by using a pseudo random number. In addition, in a case where the identification code is two-dimensionally arranged, the bit value is also two-dimensionally arranged similar to the arrangement of the code.

If the additional information is input, the additional information encoding unit 36e encodes the additional information according to a predetermined encoding scheme. For the encoding, the encoding scheme used for the encoding the position information may be used. In addition, in terms of acquiring the additional information, the additional information encoding unit 36e may be treated as additional information acquiring means.

Here, the additional information may be constructed with a configuration which can be freely set by a user AP. For example, in some user AP, an original electronic document may be acquired based on the identification information detected from a user image. Therefore, information on an acquiring method at the time of acquiring the original electronic document as the additional information can be set. For example, by using the additional information, conversion may be performed between the acquisition of the original electronic document and the acquisition of the copy of the original electronic document. In addition, conversion may also be performed into only the reading allowance in order to edit the acquired electronic document. In addition, conversion may also be performed into only the printing allowance for the acquired electronic document. Namely, by using the additional information, it is possible to control various operations for each electronic document and each medium. In addition, by using the additional information, access control for the electronic document (for example, a request for inputting user ID and password at the time of accessing the electronic document) can be performed.

On the other hand, a separate user AP may employ information on a copy allowance number (or copy allowance or prohibition) of the printed document as the additional information to control the copy number of the printed document.

The additional code generating unit 36f converts the encoded additional information into a format embedded as the code information. For example, in order that a third party can not decode the encoded additional information, the arrangement of bits in the encoded additional information may be exchanged or encrypted by using a pseudo random number. In addition, in a case where the additional code is two-dimensionally arranged, the bit value is also two-dimensionally arranged similar to the arrangement of the code.

The code arranging unit 36g combines the encoded position information, the encoded identification information, and the encoded additional information arranged with a format same as the code and generates a two-dimensional code array corresponding to an output image size. At this time, for the encoded position information, codes obtained by encoding different position information according to arranged positions are used, and for the encoded identification information and the encoded additional information, a code obtained by encoding the same position irrespective of positions is used.

The pattern image generating unit 36i checks bit values of array elements in the two-dimensional code array, acquires bit pattern images corresponding to the bit values from the pattern storage unit 36h, and outputs the code image obtained by imaging the two-dimensional code array.

In addition, these functions are embodied with cooperation of software and hardware resources. More specifically, a CPU (not shown) of the identification information managing server 300 reads a program for embodying functions of the receiving unit 30a, the correspondence information registering unit 31, the information extracting unit 33, the document image generating unit 34, the code image generating unit 36, the image combining unit 38, and the transmitting unit 30b from an external memory unit to a main memory unit and executes the program.

Next, operations of the identification information managing server 300 will be described.

In the identification information managing server 300, the receiving unit 30a receives an electronic document, a storage location thereof, a printing attribute (paper size, direction, or the like), and additional information and transmits the received information to the correspondence information registering unit 31.

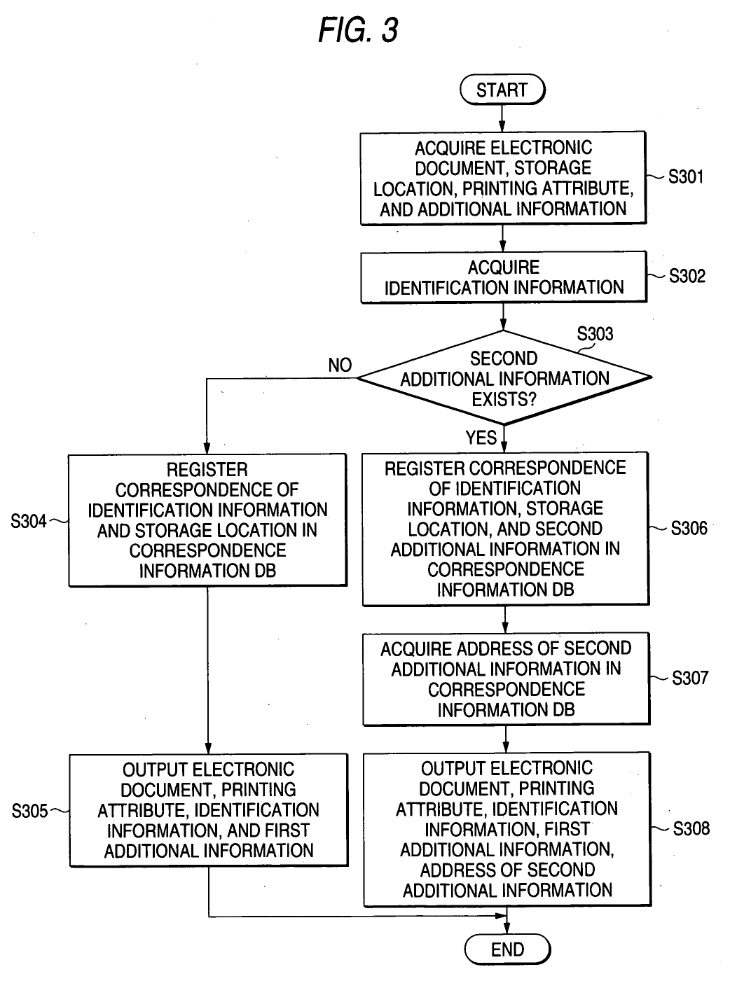

And then, the correspondence information registering unit 31 performs processes shown in FIG. 3.

Namely, the electronic document, the storage location thereof, the printing attribute, and the additional information are acquired from the receiving unit 30a (Step 301). In addition, in the embodiment, the additional information includes additional information (hereinafter, referred to as “first additional information”) which can be directly embedded as a code image into a medium in a paper and additional information (hereinafter, referred to as “second additional information”) which needs to be registered in a separate database. Since the amount of the information which can be embedded in the code image is limited, the information (second additional information) requiring a large amount of information is stored in the database, and then, extracted from the databases according to the information embedded in the code image.

Next, the correspondence information registering unit 31 extracts identification information from the identification information repository 350 (Step 302).

Next, the correspondence information registering unit 31 determines whether or not the second additional information is contained in the additional information acquired in the Step 301 (Step 303).

As a result, if the second additional information is not determined to be contained, the correspondence information to the storage location of the electronic document and the identification information are registered in the correspondence information DB 32 (Step 304). Next, the electronic document, the printing attribute, the identification information, and the additional information (first additional information) are output to the information extracting unit 33 (Step 305).

On the other hand, if the second additional information is determined to be contained, the correspondence information to the second additional information, the identification information, and the storage location of the electronic document are registered in the correspondence information DB 32 (Step 306). In addition, in the correspondence information DB 32, an address of the second additional information is acquired (Step 307). Next, the address of the second additional information acquired in Step 307, the electronic document, the printing attribute, the identification information, and the first additional information are output to the information extracting unit 33 (Step 308).

After that, the information extracting unit 33 extracts information needed for the code generating unit from the transmitted and received information. More specifically, such information includes the printing attribute, the identification information, the first additional information, and the address of the second additional information.

By doing so, in the position information encoding unit 36a, the position information corresponding to the printing attribute is encoded, and in the position code generating unit 36b, a position code indicating the encoded position information is generated. In addition, in the identification information encoding unit 36c, the identification information is encoded, and in the identification code generating unit 36d, an identification code indicating the encoded identification information is generated. In addition, in the additional information encoding unit 36e, the addresses of the first additional information and the second additional information are encoded, and in the additional code generating unit 36f, an additional code indicating the encoded additional information is generated.

Next, in the code arranging unit 36g, a two-dimensional code array corresponding to an output image size is generated, and in the pattern image generating unit 36i, a pattern image corresponding to the two-dimensional code array is generated.

On the other hand, the information extracting unit 33 transmits information on the information (information on the electronic document, or the like) in which the information needed for code generation is extracted to the document image generating unit 34, and the document image generating unit 34 generates a document image of the electronic document.

Next, finally, in the image forming unit 38, the document image generated by the document image generating unit 34 and the code image previously generated by the code image generating unit 36 are combined, and the combined image is transmitted to the transmitting unit 30b. By doing so, the transmitting unit 30b transmits the combined image to the image forming apparatus 400.

Next, the image forming apparatus 400 will be described in detail.

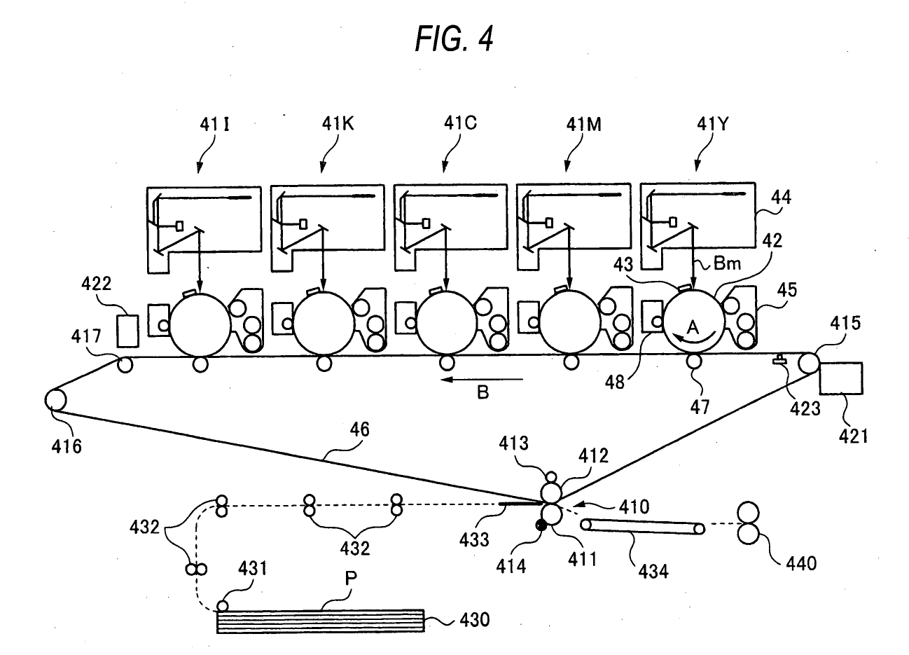

FIG. 4 is a view showing an example of a construction of the image forming apparatus 400. The image forming apparatus 400 shown in FIG. 4 is the so-called tandem type apparatus, which includes for example, plural image forming units 41 (41Y, 41M, 41C, 41K, and 41I) for forming color component toner images in an electrophotographic scheme, an intermediate transfer belt 46 for sequentially transferring (primarily transferring) the color component toner images formed in the image forming units 41 for preserving and sustaining thereof, a secondary transfer unit 410 for simultaneously transferring (secondarily transferring) overlapped images transferred on the intermediate transfer belt 46 on a paper (medium) P, and a fixing unit 440 for fixing the secondarily-transferred image on the paper P.

In addition to the image forming units 41Y, 41M, and 41C for forming general (typical) color toner images, that is, yellow Y, magenta M, and cyan C toner images, the image forming apparatus 400 includes the image forming unit 41K for forming black K toner image having no infrared absorbance and the image forming unit 41I for forming an invisible toner image as one of tandem type image forming units. In addition, composition of the toners will be described later in detail.

In the embodiment, for each of the image forming units 41 (41Y, 41M, 41C, 41K, and 41I), electrophotographic devices such as a charger 43 for charging each of photosensitive drums 42, laser photosensitive unit 44 for forming an electrostatic latent image on the photosensitive drum 42 (an exposure beam is denoted by reference numeral Bm in the figure), a developing unit 45 for containing the color component toners and forming a visible image from the electrostatic latent image on the photosensitive drum 42 by using the toner, a primary transfer roll 47 for transferring each of the color component toner images formed on the photosensitive drum 42 to an intermediate transfer belt 46, and a drum cleaner 48 for removing a residual toner on the photosensitive drum 42 are sequentially disposed around each of the photosensitive drums 42 which rotates in a direction of arrow A. The image forming units 41 are disposed in the order of yellow Y, magenta M, cyan C, black K, and invisible I colors from the upstream side of the intermediate transfer belt 46.

In addition, the intermediate transfer belt 46 is constructed to rotate in a direction of arrow B shown in the figure by means of various rolls. The various rolls include a driving roll 415 driven by a motor (not shown) to rotate the intermediate transfer belt 46, a tension roll 416 for providing a predetermined tension to the intermediate transfer belt 46 and preventing meandering of the intermediate transfer belt 46, an idle roll 417 for supporting the intermediate transfer belt 46, and a backup roll 412 (described later).

In addition, a voltage having an opposite polarity to a charging polarity is applied to the primary transfer roll 47, so that the toner images on the photosensitive drums 42 are sequentially electrostatically-sucked to the intermediate transfer belt 46 and overlapped on the intermediate transfer belt 46 to form a toner image. In addition, a secondary transfer unit 410 includes a secondary transfer roll 411 disposed to presses and contact a toner image containing surface of the intermediate transfer belt 46 and a backup roll 412 disposed to a rear surface side of the intermediate transfer belt 46 to constitute an opposite electrode of the secondary transfer roll 411. A feeding roll 413 made of a metal to which a secondary transfer bias is stably applied is disposed to contact the backup roll 412, In addition, a brush roll for removing contaminants attached on the secondary transfer roll 411 is disposed to contact the secondary transfer roll 411.

In addition, in the downstream of the secondary transfer roll 411, a belt cleaner 421 for cleaning a surface of the after-secondary-transfer intermediate transfer belt 46 is provided. On the other hand, in the upstream of the secondary transfer roll 411, an image concentration sensor 422 for adjusting image quality is disposed. In addition, in the upstream of the Y cooler image forming unit 41Y, a reference senor (home position sensor) 423 for generating a reference signal used as a reference of image forming timing in each of the image forming units 41 is disposed. The reference sensor 423 senses a predetermined mark provided to the rear surface side of the intermediate transfer belt 46 to generate the reference signal, and each of the image forming units 41 is constructed to start image forming according to a command of a control unit (not shown) based on the sensing of the reference signal.

In addition, in the embodiment, a paper conveying system includes a paper tray 430 for accommodating the paper P, a pickup roll 431 for taking out the paper P accommodated in the paper tray 430 and conveying the paper P, a conveying roll 432 for conveying the paper P wrapped from the pickup roll 431, a conveying shoot 433 for conveying the paper P conveyed by the conveying roll 432 to a secondary transfer position of the secondary transfer unit 410, and a conveying belt 434 for conveying the secondarily-transferred paper P to a fixing position 440.

Now, an image forming process of the image forming apparatus 400 will be described. When a user turns on a start switch (not shown), a predetermined image forming process is performed. More specifically, in a case where the image forming apparatus 400 is constructed with, for example, a color printer, digital image signals transmitted through the network 900 is temporarily stored in a memory, and toner image forming for the colors are performed based on the stored five color (Y, M, C, K, and I) digital image signals.

Namely, the image forming units 41 (41Y, 41M, 41C, 41K, and 41I) are driven according to the color image recording signals obtained in the image process. Next, in the image forming units 41Y, 41M, 41C, 41K, and 41I, electrostatic latent images corresponding to the image recording signals are recorded on the photosensitive drums 42 which are uniformly charged by the charger 43 by using the laser photosensitive unit 44. In addition, the recorded electrostatic latent images are developed by the developing unit 45 containing the color toners, so that the color toner images are formed.

Next, the toner images formed on the photosensitive drums 42 are primarily transferred from the photosensitive drums 42 to a surface of the intermediate transfer belt 46 by a primary transfer bias applied to the primary transfer roll 47 at primary transfer positions where photosensitive drums 42 and the intermediate transfer belt 46 are contacted to each other. As a result, the toner images primarily transferred on the intermediate transfer belt 46 are overlapped on the intermediate transfer belt 46 and conveyed to a secondary transfer position by rotation of the intermediate transfer belt 46.

On the other hand, the paper P is conveyed to the secondary transfer position of the secondary transfer unit 410 at a predetermined timing, and the secondary transfer roll 411 nips the paper P to the intermediate transfer belt 46 (backup roll 412). Next, by operation of a secondary transfer electric field formed between the secondary transfer roll 411 the backup roll 412, the overlapped toner image contained in the intermediate transfer belt 46 is secondarily transferred on the paper P.

After that, the paper P on which the toner image is transferred is conveyed to a fixing position 440 by means of the conveying belt 434, and then, the fixing of the toner image is performed. On the other hand, residual toners are removed from the after-secondary-transfer intermediate transfer belt 46 by a belt cleaner 421.

Now, the toners used for the image forming apparatus 400 will be described.

Firstly, conventionally used toners are used as the Y toner used in the image forming unit 41Y, the M toner used in the image forming unit 41M, and the C toner used in the image forming unit 41C.

On the contrary, in the embodiment, a particular toner is prepared as the K toner used for the image forming unit 41K. Since a conventionally used K toner made of a black material such as carbon black absorbs infrared light, in the system for reading the information embedded with the invisible toner, the conventionally used K toner is not suitable to form a general image where the information is not embedded. Namely, in the embodiment, a toner having an extremely lower infrared light absorbance and capable of printing black color is used as the K toner. A toner obtained by mixing the Y toner, the M toner, and C toner is exemplified as the toner.

In addition, although the particular toner having different characteristic from the conventionally used K toner used, the particular toner is denoted as “K toner” in the specification for the convenience of description.

In addition, as the invisible toner used in the image forming unit 41I, for example, a material disclosed in JP-A-2003-186238 may be used. Namely, a toner including a near-infrared light absorbing material made of a binding resin and inorganic particles may be used.

Here, more specifically, the binding resin includes polystyrene, styrene acrylic acid alkyl copolymer, styrene metacrylic acid alkyl copolymer, styrene acrylonitrile copolymer, styrene butadiene copolymer, styrene maleic acid anhydride copolymer, polyethylene, polypropylene, and the like.

In addition, as the near-infrared light absorbing material, inorganic particles containing at least CuO and P₂O₅ may be used. In addition, a concentration of CuO components in the invisible toner particles is preferably in a range of 6 wt % to 35 wt %, and more preferably, in a range of 10 wt % to 30 wt %. In addition, in order to obtain an uniform dispersion property of the inorganic particles in the invisible toner and a suitable negative abrasion charging property needed for an electrophotographic recording material, the inorganic particles are preferably made of a copper phosphate crystallized glass having requisite components of CuO, Al₂O₃, P₂O₅, and K₂O. As a preferable composition of the copper phosphate crystallized glass, CuO is in a range of 20 wt % to 60 wt %, Al₂O₃ is in a range of 1 wt % to 10 wt %, P₂O₅ is in a range of 30 wt % to 70 wt %, and K₂O is in a range of 1 wt % to 10 wt %

Namely, the image forming apparatus 400 form the code image with a material (substantially invisible color material) which cannot be discriminated with human eyes and the document image with a material (visible color material) which can be discriminated with human eyes. In addition, a material having a characteristic that a wavelength in a specific infrared range is more absorbed than a wavelength in a visible range is used as the invisible color material, and a material having a characteristic that a wavelength in a visible range is more absorbed is used as the visible color material.

In addition, in the embodiment, although an example of using the invisible color material is described, the present invention is not limited thereto. For example, the code image may be formed by using carbon black which absorbs a wavelength in an infrared range, and the document image may be formed by using yellow, magenta, and cyan color materials (generally, the color materials have a low absorbance to a wavelength in a infrared range).

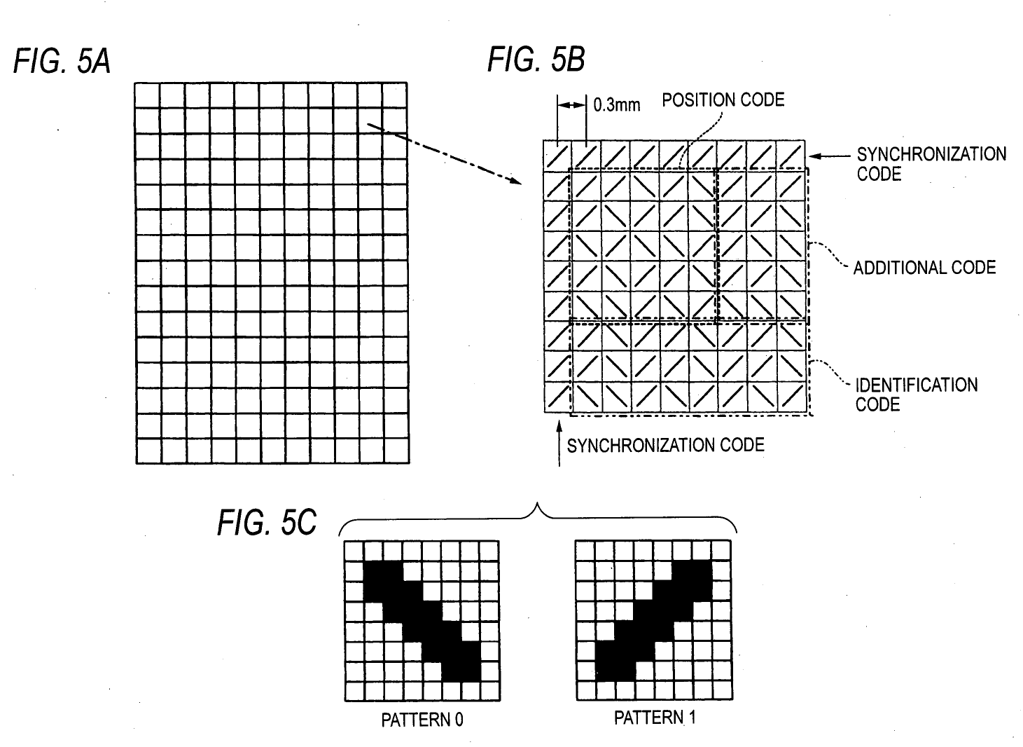

FIGS. 5A to 5C are views for explaining a two-dimensional code image generated by the code image generating unit 36 of the identification information managing server 300 and printed by the image forming apparatus 400. FIG. 5A is a view showing a lattice schematically representing a unit of the two-dimensional code image formed and disposed with the invisible image. In addition, FIG. 5B is a view showing a single unit of the two-dimensional code image where the invisible image is discriminated by means of infrared light illumination. In addition, FIG. 5C is a view for explaining a slant pattern of backslash “\” and slash “/”.

The two-dimensional code image formed in the image forming apparatus 400 is formed with an invisible toner having a maximum absorbance of, for example, 7% or less at a visible range (400 nm to 700 nm) and an absorbance of, for example, 30% or more at a near-infrared range (800 nm to 1000 nm). In addition, the invisible toner has an average dispersion diameter of 100 nm to 600 nm in order to increase the near-infrared absorbance needed for machine-reading of the image. Here, the terms “visible” and “invisible” are not related to whether or not to be discriminated with human eyes. The “visible” and “invisible” are determined by whether or not an image printed on a medium can be discriminated with presence or absence of a color generating property due to absorbance of a specific wavelength in a visible range.

The two-dimensional code images shown in FIGS. 5A to 5C are formed with the invisible image by which the machine-reading process by means of the infrared light illumination and the decoding process can be stably performed in a long time and the information can be recorded with a high density thereof. In addition, an invisible image which can be provided to an arbitrary region irrespective of a region to which the visible image on a medium surface is provided for outputting an image is preferred. In the embodiment, the invisible image is formed on the entire surface of one medium surface (paper surface) matched with a size of the printing medium. In addition, an invisible image which can be discriminated according to glossiness difference as seen with human eyes is more preferred. However, the “entire surface” does not denote that the surface includes the four corners of the paper. In the electrophotographic apparatus, since there is generally a region where the printing can not be performed, the invisible image dos not need to be printed in the region.

The two-dimensional code pattern shown in FIG. 5B includes a region for storing a position code indicating coordinate positions on the medium, a region for storing an identification code uniquely specifying an electronic document or a printing medium, and a region for storing an additional code used in a user AP. In addition, a region for storing a synchronization code is also included. In addition, as shown in FIG. 5A, the plural two-dimensional code patterns are disposed, and two-dimensional codes in which different position information is stored is disposed in a shape of lattice on the entire surface of one medium surface (bottom surface) matched with a size of the printing medium. Namely, plural two-dimensional code patterns shown in FIG. 5B are disposed on the one medium surface, and each of the patterns includes a position code, an additional code, an identification code, and a synchronization code. In addition, in regions of the plural position codes, different position information is stored according to the arranged locations thereof. On the other hand, in regions of the plural identification codes and additional codes, the same identification information and additional information are stored irrespective of the arranged locations thereof.

In FIG. 5B the position code is disposed within a 5 bit×5 bit rectangular region. Each of bit values is formed plural fine line bitmaps having different rotational angles, and bit value 0 and bit value 1 are represented with slanted patterns (pattern 0 and pattern 1). More specifically, bit 0 and bit 1 are represented by using backslash “\” and slash “/” having different is slopes. The slanted pattern is constructed with 600 dpi in a size of 8×8 pixels, and a leftward rising slanted pattern (pattern 0) and a rightward rising slanted pattern (pattern 1) represent bits value 0 and bit value 1, respectively. Therefore, 1-bit information 0 of 1 can be represented with a single one slanted pattern. By use of the fine line bitmaps constructed with two different slopes, the two-dimensional code pattern having an extremely small noise applied to the visible image and capable of digitalizing and embedding a large amount of information with a high density can be provided.

Namely, in the region of the position code shown in FIG. 5B, the position information having a total of 25 bits is stored. Among the 25 bits, 12 bits can be used for am X coordinate encoding process, and 12 bits can be used for a Y coordinate encoding process. The remaining 1 bit may be used for any one of the two encoding processes. If all the 12 bits are used for a position encoding process, 2¹² (4096) positions can be encoded. In a case where each of the slanted patterns is constructed with 8 pixel×8 pixel (600 dpi) as shown in FIG. 5C, since one dot of 600 dpi has a size of 0.0423 mm, a size of the two-dimensional code (including the synchronization code) shown in FIG. 5B has an aspect ratio of about 3 mm (8 pixel×9 bit×0.0423 mm). In a case where the 4096 positions are encoded in an interval of 3 mm, a length of about 12 m can be encoded. Like this, all the 12 bits may be used for the position encoding process. Alternatively, in a case where a detection error of the slanted pattern occurs, a redundant bit for error detection or error correction may be included.

In addition, the identification code is disposed within a 3 bit×8 bit rectangular region and can store the identification information having a total of 24 bits. In a case where the 24 bits are used for the identification information, 2²⁴ (about 17,000,000) of identification information can be represented. Similar to the position code, the identification code may also include a redundant bit for error detection or error correction among the 24 bits.

On the other hand, the additional code is disposed within a 5 bit×3 bit rectangular region and can store the identification information having a total of 15 bits. In a case where the 15 bits are used to the additional information, 2¹⁵ (about 33,000) of additional information can be represented. Similar to the identification code of the position code, the additional code may also include a redundant bit for error detection or error correction among the 15 bits.

In addition, although the two slanted patterns have an angle difference of 90° in the example shown in FIG. 5C, if the angle difference is set to 45°, four types of slanted patterns can be constructed. In such a construction, 2-bit information 0 to 3 can be represented with a single one slanted pattern. Namely, by increasing angel types of the slanted patterns, the number of bits which can be represented can increase.

In addition, although the encoding of the bit values is described by using the slanted patterns in the example shown in FIG. 5C, the pattern which can be selected is not limited to the slanted patterns. A method of encoding ON/OFF of dots or positions of dots according to directions deviated from a reference position may be employed.

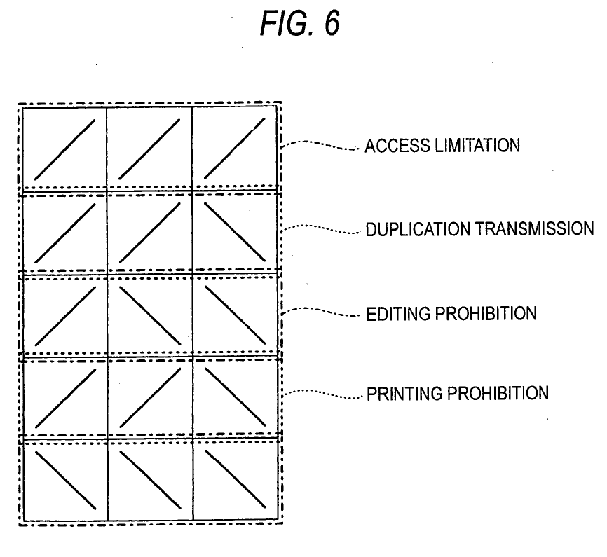

FIG. 6 is a detailed view showing a region where the additional code is disposed.

Although the information included in the additional code may be determined to be suitable for a user AP, access limitation, duplication transmission, editing prohibition, and printing prohibition are set in the figure. In addition, since there is a limitation to the amount of information which can be included in the additional code, more detailed additional information (second additional information) is stored in a database (for example, a correspondence information DB 32 in FIG. 2), and information used for referring to the database is embedded in the additional code.

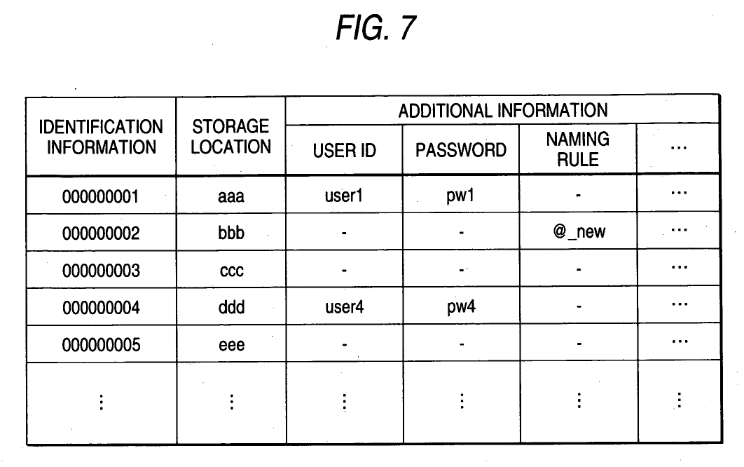

In this case, for example, a first bit represents whether or not a control is performed on items of the access limitation, the copy transmission, the editing prohibition, and the printing prohibition. In addition, second and third bits represent a storage location of the second additional information in the database. In addition, in the embodiment, the second additional information for the access limitation is a user ID and password, and the second additional information for the duplication transmission is a naming rule. On the contrary, there is no second additional information for the editing prohibition and the printing prohibition, because the editing prohibition and the printing prohibition simply determine whether or not the editing or the printing is prohibited. In addition, FIG. 7 is a view showing an example of contents stored in the correspondence information DB 32 which can be included in the code image.

As shown in the figure, the correspondence information DB 32 stores the identification information, the storage location of the electronic document, and the correspondence of the second additional information. Here, as described above, since the user ID and password are needed for the second additional information for the access limitation, the information is stored. Namely, it is defined that, if the user ID “user1” and the password “pw1” are input, the electronic document in the storage location “aaa” can be accessed. In addition, as described above, since the naming rule is needed for the duplication transmission, the information is stored. Namely, it is defined that, before the electronic document in the storage location “bbb” is transmitted, the duplication is performed, and a file name of the original electronic document followed by “_new” is transmitted as a file name of the after-duplication electronic document.

In addition, since the additional information is simply embedded in the code image, the identification information “00000003” and “000000005” are examples where the correspondence of the additional information is not needed by the correspondence of the identification information and the storage location.

Now, a pen device 600 will be described in detail.

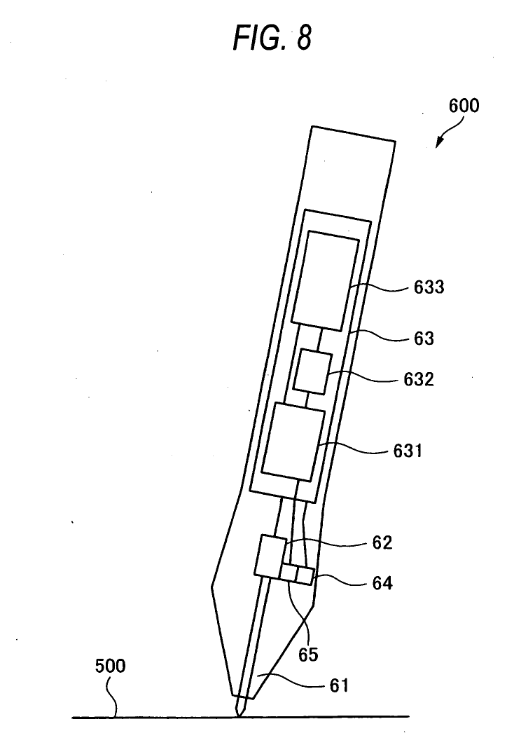

FIG. 8 is a view showing a construction of the pen device 600.

The pen device 600 includes a writing member 61 for writing characters or diagrams on a paper (medium) on which a code image and a document image are combined and printed by operations similar to a general pen and a wiring pressure detection unit 62 for monitoring a motion of the writing member 61 and detecting the pressing of the pen device 600 on the paper. In addition, the pen device 600 further includes a control unit 63 for controlling whole electronic operations of the pen device 600, an infrared light illuminating unit 64 for illuminating infrared light to read out the code image on the paper, and an image input unit 65 for discriminating and inputting the code image by receiving the reflected infrared light.

Here, the control unit 63 will be described in more detail.

The control unit 63 includes a code acquiring unit 631, a trajectory calculation unit 632, and an information storage unit 633. The code acquiring unit 631 is a unit for acquiring a code by analyzing an image input from the image input unit 65. The trajectory calculation unit 632 is a unit for calculating a trajectory of a pen nib by correcting a deviation of a coordinate of the pen nib of the writing member 61 and a coordinate of the image acquired by the image input unit 65 with respect to the code acquired by the code acquiring unit 631. The information storage unit 633 is a unit for storing the code acquired by the code acquiring unit 631 or the trajectory information calculated by the trajectory calculation unit 632.

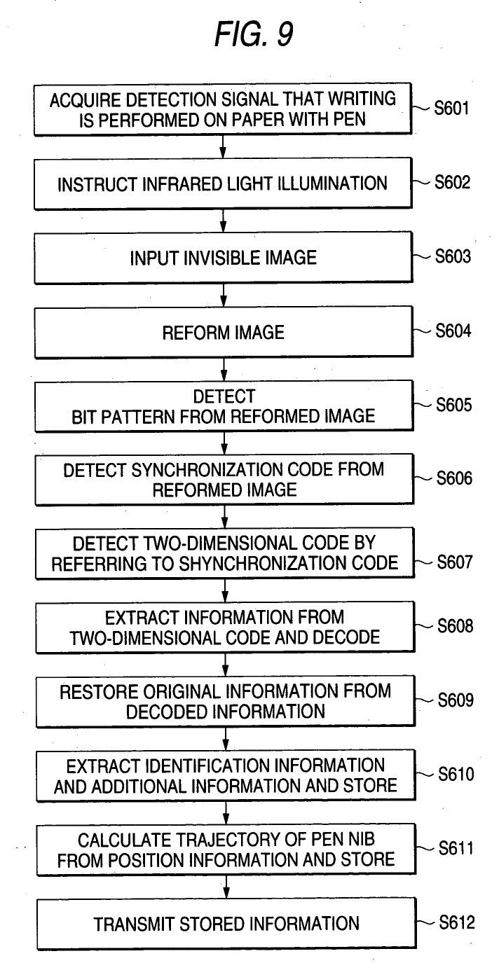

FIG. 9 is a flowchart showing a process of the pen device 600 mainly executed by the control unit 63. For example, if the writing of the character or the diagram on the paper is performed by using the pen device 600, the control unit 63 acquires from the writing pressure detection unit 61 a detection signal that the writing of the pen on the paper is performed (Step 601). If the detection signal is detected, the control unit 63 commands the infrared light illuminating unit 64 to illuminate infrared light on the paper (Step 602). The infrared light illuminated on the paper by the infrared light illuminating unit 64 is absorbed by the invisible image and reflected by the other portion. The image input unit 65 receives the reflected infrared light and discriminates the other portion on which the infrared light is not reflected as the code image. The control unit 63 inputs and scans the code image from the image input unit 65 (Step 603).

After that, in the code acquiring unit 631 of the control unit 63, code image detection processes shown in Steps 604 to 610 is performed. Firstly, the code acquiring unit 631 reforms the input scan image (Step 604). The reforming of the scan image includes slope correcting, noise removing, or the like. Next, bit patterns (slanted patterns) of slash “/”, backslash “\”, or the like are detected from the reformed scan image (Step 605). On the other hand, a synchronization code for determining a two-dimensional code position is detected from the reformed scan image (Step 606). The code acquiring unit 631 detects the two-dimensional code by referring to the synchronization code position (Step 607). In addition, information such as ECC (error correction code) is extracted from the two-dimensional code and decoded (Step 608). Next, the decoded information is restored into original information (Step 609).

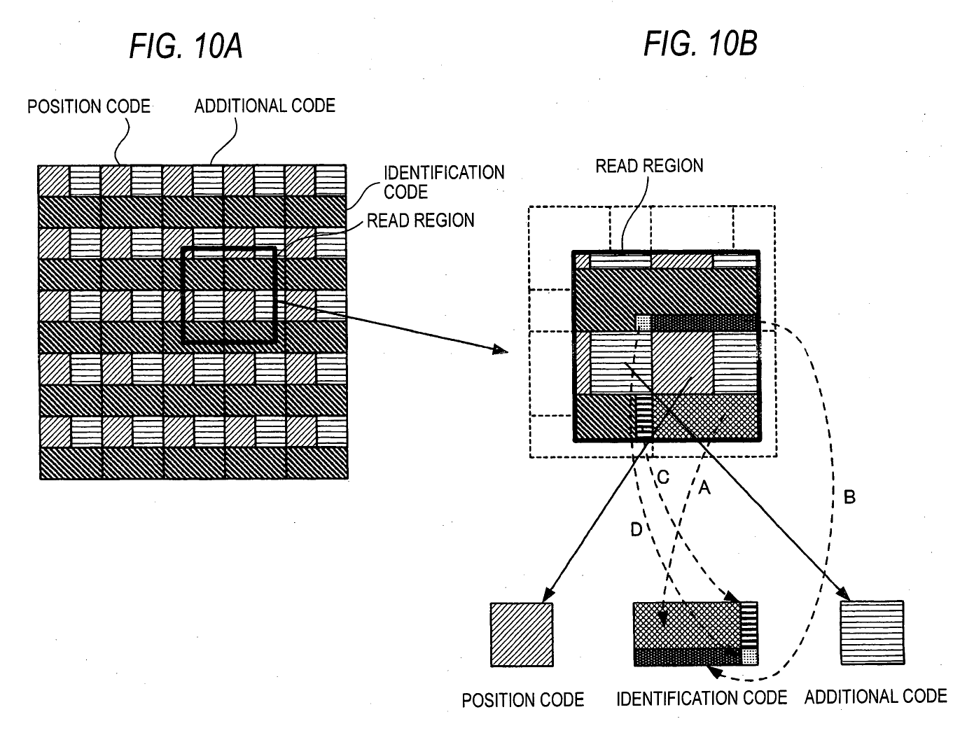

FIGS. 10A and 10B are views for explaining reading of code information in the pen device 600. As shown in FIG. 10A, plural position codes (code corresponding to the position information), plural identification codes (code corresponding to the identification information), and plural additional codes (code corresponding to additional information) are two-dimensionally disposed on a printed medium. In addition, for the convenience of description, in FIG. 10A, a synchronization code is not shown. As described above, plural position codes store different position information according to arranged locations thereof, and plural identification codes and plural additional codes store the same identification information and the same additional information irrespective of the arranged locations thereof. In this case, the read region of the invisible image read by the image input unit 65 is indicated by a bold line in FIG. 10A. An enlarged view of a vicinity of the read region is shown in FIG. 10B. Since the position codes store different information according to positions in the image, it is not detected that one or more position code is not always included in the read image. However, since the identification codes and the additional code store the same identification information and the same additional information irrespective of the arranged locations, restoration form fragmentary information is available. In the example shown in FIG. 10B, one identification code is restored by combination of four partial codes A, B, C, and D in the read region.

In the code acquiring unit 631 of the control unit 63, the position information, the identification information, and the additional information are acquired from the restored code information, and the acquired information is stored in the information storage unit 633 (Step 610). On the other hand, the trajectory calculation unit 632 calculates a trajectory of the pen nib from the coordinate information stored in the information storage unit 633 and stores the calculated trajectory in the information storage unit 633 (Step 611). The stored information such as the identification information, the additional information, and the trajectory information stored in the information storage unit 633 is transmitted to, for example, a terminal apparatus 700 in a wire or wireless manner (Step 612).

The terminal apparatus 700 receiving the information performs an operation of acquiring the electronic document managed in the document managing server 200. However, in this case, since the correspondence between the identification information and the storage location of the electronic document is managed in the identification information managing server 300, the terminal apparatus 700 sends a query to identification information managing server 300.

Now, the identification information managing server 300 which operates in response to the query will be described in detail.

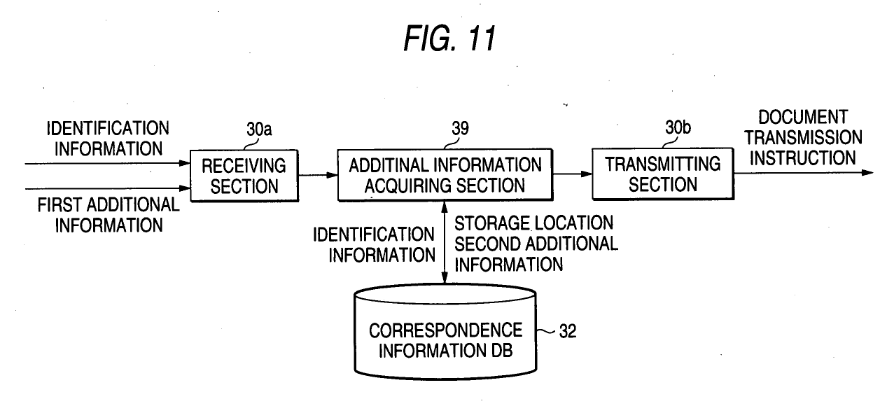

FIG. 11 is a view showing an example of a construction of the identification information managing server 300. In addition, although FIG. 11 shows a construction of the identification information managing server 300 similar to FIG. 2, FIG. 2 shows a construction of image forming among the construction of the identification information managing server 300, but FIG. 11 shows a construction of a process based on a read image. Therefore, a whole construction of the identification information managing server 300 is a combination of the constructions shown in FIGS. 2 and 11.

The identification information managing server 300 includes a receiving unit 30a, an additional information acquiring unit 39, and a receiving unit 30b.

The receiving unit 30a receives identification information and first additional information from a network 900 and transmits the information to an additional information acquiring unit 39.

If there is second additional information on an electronic document corresponding to the identification information acquired from the receiving unit 30a, the additional information acquiring unit 39 the second additional information, perform a process based on the additional information, and prepares a document transmission command for transmission to the terminal apparatus 700.

The transmitting unit 30b transmits the document transmission command prepared by the additional information acquiring unit 39 through the network 900 to a document managing server 200.

In addition, these functions are embodied with cooperation of software and hardware resources. More specifically, a CPU (not shown) of the identification information managing server 300 reads a program for embodying functions of the receiving unit 30a, the additional information acquiring unit 39, and the transmitting unit 30b from an external memory unit to a main memory unit and executes the program.

Now, operation of the identification information managing server 300 in this case will be described.

In the identification information managing server 300, the receiving unit 30a firstly receives the identification information and the additional information and transmits the received information to the additional information acquiring unit 39.

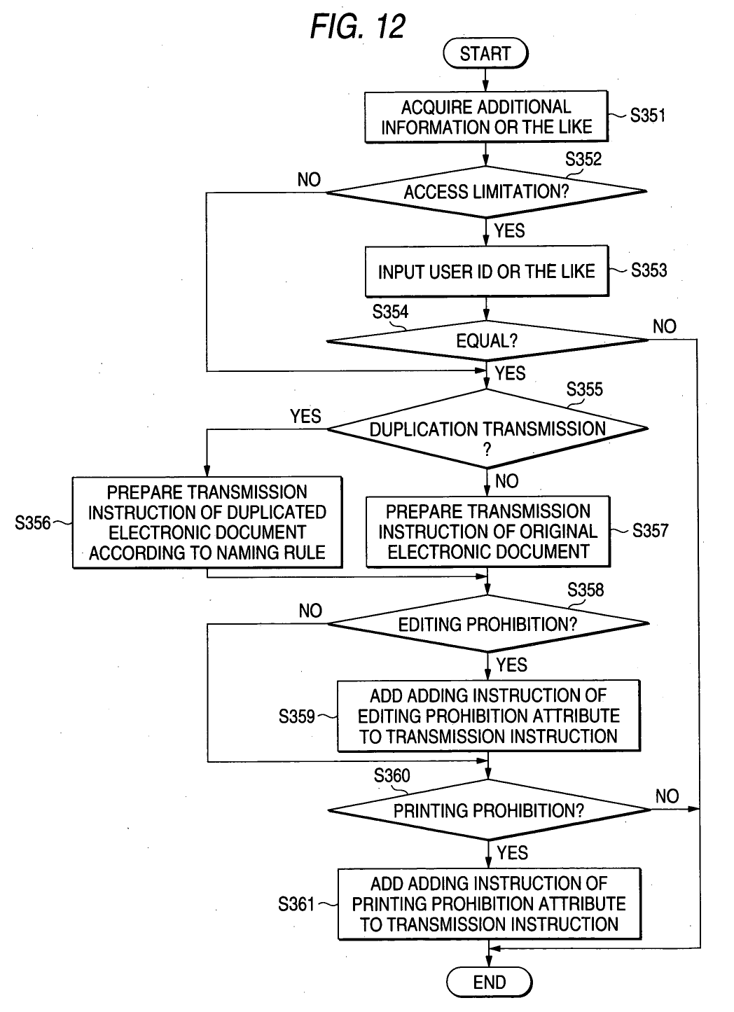

Next, the additional information acquiring unit 39 performs processes shown in FIG. 12.

Namely, the identification information and the additional information are acquired from the receiving unit 30a (Step 351).

As described above, in the embodiment, four items of access limitation, duplication transmission, editing prohibition, and printing prohibition are set as the additional information. Therefore, hereinafter, a process based on a result of estimation of the items is preformed.

Firstly, the additional information acquiring unit 39 determines whether or not access is limited by referring to the additional information acquired from the receiving unit 30a (Step 352). As a result, if the access is not determined to be limited, the process proceeds to Step 355. On the other hand, if the access is determined to be limited, a command is provided to the transmitting unit 30b to transmit an input screen is of user ID and password to the terminal apparatus 700 (Step 353).

The input screen of user ID and password is displayed on the terminal apparatus 700, and a user inputs the user ID and password.

The user ID and password are transmitted through the network 900 to the receiving unit 30a, and then, transmitted from the receiving unit 30a to the additional information acquiring unit 39. Next, the additional information acquiring unit 39 determines whether or not the transmitted user ID and password are equal to user ID and password registered in a correspondence information DB 32 with respect to the identification information previously acquired from receiving unit 30a (Step 354).

As a result, if the user ID and password are not equal to the registered user ID and password, access to electronic document is refused, the process ends. On the other hand, if the user ID and password are equal to the registered user ID and password, access to the electronic document is accepted, the process proceeds to Step 355.

Here, the additional information acquiring unit 39 determines whether or not duplication transmission is commanded with reference to the additional information acquired from the receiving unit 30a (Step 355). As a result, if the duplication transmission is determined to be commanded, the additional information registered in the correspondence information DB 32 for the identification information acquired from the receiving unit 30a is referred. Next, the electronic document specified in the identification information is duplicated, a name of the duplicated electronic document is changed according to a naming rule, and a document transmission command for transmission to the terminal apparatus 700 is prepared (Step 356). On the other hand, if the duplication transmission is not determined to be commanded, a document transmission command for transmitting the electronic document specified in the identification information to the terminal apparatus 700 is prepared (Step 357).

In addition, the additional information acquiring unit 39 determines whether or not editing prohibition is commanded by referring to the additional information acquired from the receiving unit 30a (Step 358). As a result, if the editing prohibition is not determined to be commanded, the process proceeds to Step 360 without any operation. On the other hand, if the editing prohibition is determined to be commanded, a command for adding a editing prohibition attribute at the time of transmitting the electronic document is added to the document transmission command prepared in Step 356 or 357 (Step 359).

In addition, the additional information acquiring unit 39 determines whether or not printing prohibition is commanded by referring to the additional information acquired from the receiving unit 30a (Step 360). As a result, if the printing prohibition is not determined to be commanded, the process ends without any operation. On the other hand, if the printing prohibition is determined to be commanded, a command for adding a printing prohibition attribute at the time of transmitting the electronic document is added to the document transmission command prepared in Step 356 or 357 (Step 361).

After that, the prepared document transmission command is transmitted to the transmitting unit 30b, and the transmitting unit 30b transmits the command through the network 900 to the document managing server 200.

Next, the document managing server 200 ads attributes for the duplication and the editing or printing prohibition of the electronic document according to the received document transmission command, if necessary, and then, transmits the electronic document to the terminal apparatus 700.

By doing so, the operation of the first embodiment ends.

In addition, although the additional information is exemplified by four items of the access limitation, the duplication transmission, the editing prohibition, and the printing prohibition in the embodiment, the present invention is not limited thereto. Any information which can be treated as information on acquisition limitation of an electronic document, process limitation at the time of acquiring the electronic document, and operation limitation after the acquisition of the electronic document is available. Furthermore, any information which can be used for a process of the electronic document is available.

In addition, although the access limitation is not performed at the time that the pen device acquires the identification information or the position information on the medium in the embodiment, access control may be performed by using the additional information. Namely, the pen device is initially set to read only the information in an additional code region specified a synchronization code. Next, in a case where the additional information represents access limitation, only it a user is identified as an authentic user by means of an authentication process, the identification information or the position information can be read. In this case, the additional information can be treated as information on limitation to reading information from a medium, and furthermore, as information used for a process for the medium.

### SECOND EMBODIMENT

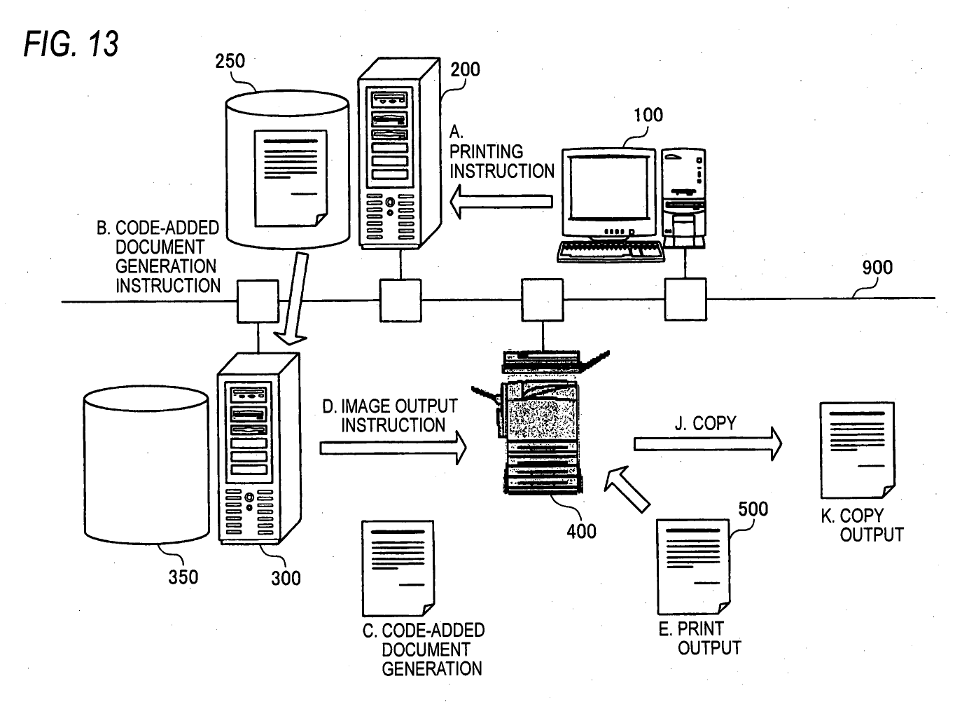

FIG. 13 is a view showing an example of a construction of a system to which a second embodiment is applied. The system has a construction where the pen device 600 and the terminal apparatus 700 are removed from the construction of the system shown in FIG. 1. Namely, although the system has the same construction as that of the system shown in FIG. 1 until the code-image-added paper 500 is output, the code-image-added paper 500 is copied in the image forming apparatus 400 (J), and then, an after-copy code-image-added paper is obtained (K).

Now, components of the system shown in FIG. 13 will be described in more detail.

In the embodiment, a construction and operation for image generation of the identification information managing server 300 and a construction and operation for image formation of an image on which a document image and a code image are overlapped in the image forming apparatus 400 are the same as those of the first embodiment, and thus, description thereof will be omitted.

In addition, a two-dimensional code image generated by the code image generating unit 36 of the identification information managing server 300 and printed by the image forming apparatus 400 is the same as that of the first embodiment, description thereof will be omitted.

In the first embodiment, information used fro a process for the electronic document is treated as the additional information, and for example, access limitation, duplication transmission, editing prohibition, and printing prohibition is embedded therein. On the contrary, in the second embodiment, information used for a process for the medium is treated as the additional information, and copy prohibition and copy allowance number are embedded in the additional information therein.

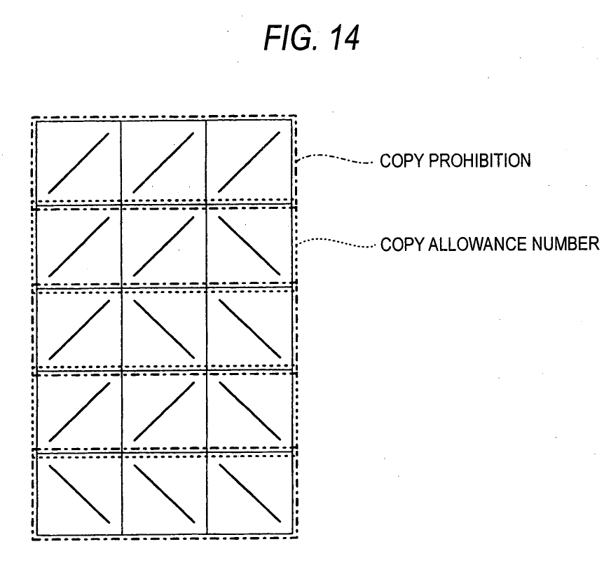

FIG. 14 is a view showing a construction where additional codes are arranged.

Although the information included in the additional code may be determined to be suitable for a user AP, copy prohibition and copy allowance number are set. In addition, although there is a limitation to the amount of information which can be included in the additional code, all the required information can be embedded in the additional code in the embodiment.

In the embodiment, for example, with respect to the copy prohibition, a first bit represents whether or not copy is prohibited. In addition, with respect to the copy allowance number, the first to third bits represent the copy allowance number. However, in a case where the copy allowance number cannot be represented with 3 bits, a larger number of bits are allocated thereto.

Now, the image forming apparatus 400 used to copy the image on which the document image and the code image are overlapped will be described.

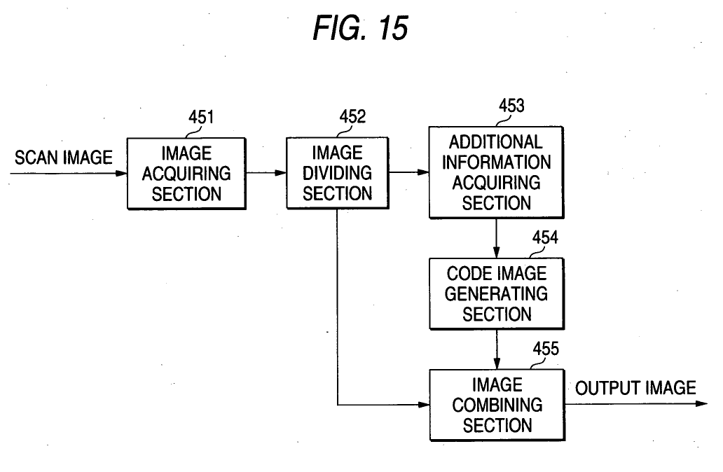

FIG. 15 is a view showing an example of a construction of an image processing unit in the image forming apparatus 400

The image processing unit includes an image acquiring unit 451, an image dividing unit 452, an additional information acquiring unit 453, a code image generating unit 454, and an image combining unit 455.

The image acquiring unit 451 inputs an image read by a scanner of the image forming apparatus 400 and transmits the image to the image dividing unit 452.

The image dividing unit 452 divides the image acquired from the image acquiring unit 451 into a document image and a code image and transmits the former to the image combining unit 455 and the latter to the additional information acquiring unit 453. In addition, as described in the first embodiment, if the code image is formed with an infrared-absorbing invisible toner, the scanner of the image forming apparatus 400 in the embodiment needs to have an infrared light illumination function. By doing so, since a position of the code image can be discriminated, the division into the document image and the code image can be performed in the image dividing unit 452

The additional information acquiring unit 453 acquires the additional information from the code image acquired from the image dividing unit 452.

The code image generating unit 454 changes the additional information and generates a new code image, if the additional information needs to be embedded in the code image.

The image combining unit 455 combines the document image transmitted from the image dividing unit 452 with the new code image generated by the code image generating unit 454.

Now, operations of the image processing unit of the image forming apparatus 400 will be described.

In the image processing unit, firstly, the image acquiring unit 451 acquires a scan image, and the image dividing unit 452 divides the scan image into a document image and a code image.

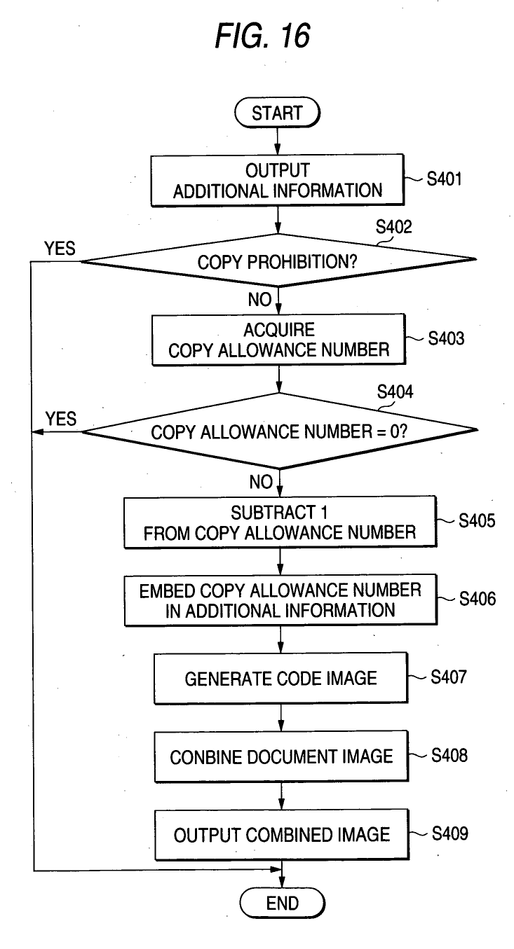

After that, the image processing unit performs processes shown in FIG. 16.

Firstly, the additional information acquiring unit 453 acquires additional information from the code image acquired from the image dividing unit 452 (Step 401).

As described above, in the embodiment, two items of copy prohibition and copy allowance number are set as the additional information. Therefore, hereinafter, a process based on a result of estimation of the items is preformed.

Firstly, the additional information acquiring unit 453 determines whether or not copy is prohibited by referring to the additional information acquired from Step 401 (Step 402). As a result, if the copy is determined to be prohibited, for example, a message that the copy is not available is notified to a user, and the process ends. On the other hand, if the copy is not determined to be prohibited, the copy allowance number is acquired by referring to the additional information again (Step 403). Next, it is determined whether or not the copy allowance number is “0” (Step 404).

Here, if the copy allowance number is “0”, for example, a message that the copy is not available is notified to the user similar to the case of the copy prohibition. On the other hand, if the copy allowance number is not “0”, “1” is subtracted from the copy allowance number (Step 405), and the after-subtraction copy allowance number is embedded in the additional information (Step 406).

By doing so, the code image generating unit 454 generates a code image in which new additional information is embedded (Step 407). Next, the image combining unit 455 combines the document image transmitted form the image dividing unit 452 and the code image generated in Step 407 (Step 408), and outputs the combined image to a main body (machine in FIG. 4) of the image forming apparatus 400 (Step 409).

After that, the image forming apparatus 400 prints the output combined image on the medium, and the user obtains a copy material in which the additional information having a copy allowance number reduced by 1.

By doing so, the operation of the second embodiment ends.

In addition, although the copy allowance number is embedded in the code image and the copy allowance number in the code image is updated at the time of copy in the embodiment, the present invention is not limited to the construction. Namely, the copy allowance number may be stored as the second additional information in the correspondence information DB, and every time that the medium is copied, the copy allowance number in the correspondence information DB may be reduced.

In addition, although the additional information is exemplified by two items of the copy prohibition and the copy allowance number in the embodiment, the present invention is not limited thereto. Any information which can be treated as information on copy limitation of a medium copy is available, and furthermore, any information which can be used for a process for the medium is available.

As described above, in the embodiment, additional information used in a user AP is included in a code image and overlapped and printed with a document image. According to the construction, it is possible to increase a degree of freedom of a service for integrating an electronic document with a medium such as a paper.

According to an aspect of the present invention, additional information which can be freely set in a user application program is embedded in a code image.

In addition, here, since the position information and the identification information are prepared in a system side, the position information and the identification information are provided by a first apparatus (for example, an identification information managing server) existing in the system side, and since the additional information is input by a user side, the additional information is provided by a second apparatus (for example, a terminal apparatus) existing in the user side.

In addition, for example, according to another aspect, the present invention provides an image forming apparatus for forming an image generated by an image generating apparatus.

In addition, according to still another aspect, the present invention provides an information processing apparatus for reading information from a code image and performing a process.

In addition, according to further still another aspect, the present invention provides a printing medium used for the process.

In addition, according to further still another aspect, the present invention provides a method of embedding additional information which can be freely set in a user application program in a code image.

On the other hand, according to further still another aspect, the present invention provides a program for embodying predetermined functions on a computer.

The entire disclosure of Japanese Patent Application No. 2005-171684 filed on Jun. 10, 2005 including specification, claims, drawings and abstract is incorporated herein by reference in its entirety.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined solely by the following claims and their equivalents.

What is claimed is:

1. An image generating apparatus comprising:
a position information acquiring unit that acquires position information indicating each of positions on a medium;
an identification information acquiring unit that acquires identification information identifying an electronic document or the medium, the electronic document being a basis of a document image formed on the medium;
an additional information acquiring unit that acquires additional information used for a user application program; and
a code image generating unit that generates a code image indicating the position information acquired by the position information acquiring unit, the identification information acquired by the identification information acquiring unit, and the additional information acquired by the additional information acquiring unit.

2. The image generating apparatus according to claim 1,
wherein the additional information is information used for a process for the electronic document.

3. The image generating apparatus according to claim 2,
wherein the additional information is information concerning at least one of a limitation on acquisition of the electronic document, a process at a time of acquisition of the electronic document, and a limitation on operation after acquisition of the electronic document.

4. The image generating apparatus according to claim 1,
wherein the additional information is information used for a process for the medium.

5. The image generating apparatus according to claim 4,
wherein the additional information is information concerning at least one of a limitation on copying the medium and a limitation on reading information from the medium.

6. The image generating apparatus according to claim 1,
further comprising a first apparatus and a second apparatus,
wherein the position information and the identification information are provided by the first apparatus, and
the additional information is provided by the second apparatus.

7. An image forming apparatus comprising:
a document image generating section that generates a document image formed on a medium;
a code image generating section that generates a code image indicating position information indicating each of positions on the medium, identification information identifying an electronic document or the medium, the electronic document being a basis of the document image, and additional information used for a process for the electronic document or the medium;
an image combining section that combines the document image generated by the document image generating section with the code image generated by the code image generating section; and
an image forming section that forms an image combined by the image combining section on the medium.

8. The image forming apparatus according to claim 7,
wherein the image forming section forms the document image as a visible image, and the code image as a substantially invisible image.

9. The image forming apparatus according to claim 7,
wherein the image forming section forms the document image with yellow, magenta, and cyan color materials, and the code image with an infrared-absorbing material.

10. The image forming apparatus according to claim 9,
wherein the image forming section forms the document image with a color material including a black color material having a lower infrared absorbance than the infrared-absorbing material.

11. An information processing apparatus comprising:
an additional information acquiring section that acquires additional information additionally provided to position information indicating each of positions on a medium and to identification information identifying data or the medium, the data being a basis of an image formed on the medium in a code image formed on the medium; and
a processing section that performs a predetermined operation according to the additional information acquired by the additional information acquiring section.

12. The information processing apparatus according to claim 11,
wherein the additional information is information used for a process for the data, and
the processing section performs the process for the data by using the additional information.

13. The information processing apparatus according to claim 11,
wherein the additional information is information used for a process for the medium, and
the processing section performs the process for the medium by using the additional information.

14. A printing medium comprising:
a first image based on predetermined data; and
a second image indicating position information on a plane having extended portions in two different directions of the second image, identification information identifying the second image or the data, and additional information used for a process for the second image or the data.

15. The printing medium according to claim 14,
wherein the first image is formed as a visible image, and
the second image is formed as a substantially invisible image.

16. The printing medium according to claim 14,
wherein the first image is formed with yellow, magenta, and cyan color materials, and
the second image is formed with an infrared-absorbing material.

17. An image generating method comprising:
acquiring position information indicating each of positions on a medium;
acquiring identification information identifying data or the medium, the data being a basis of an image formed on the medium;
acquiring additional information used for a user application program; and
generating a code image indicating the position information, the identification information, and the additional information.

18. The image generating method according to claim 17,
wherein the additional information is information used for a process for the data.

19. The image generating method according to claim 17,
wherein the additional information is information used for a process for the medium.

20. A storage medium readable by a computer, the storage medium storing a program of instructions executable by the computer to perform a function for generating image, the function comprising the steps of:
acquiring position information indicating each of positions on a medium;
acquiring identification information identifying data or the medium, the data being a basis of an image formed on the medium;
acquiring additional information used for a user application program; and
generating a code image indicating the position information, the identification information, and the additional information.

21. A storage medium readable by a computer, the storage medium storing a program of instructions executable by the computer to perform a function for generating image, the function comprising the steps of:
acquiring additional information additionally provided to each of position information indicating positions on a medium and to identification information identifying the medium or data which is a basis of an image formed on the medium in a code image formed on the medium; and
performing a predetermined operation according to the acquired additional information.
